(19) United States
(12) Patent Application Publication
(10) Pub. No.: US 2015/0145950 A1
(43) Pub. Date: May 28, 2015

(54) MULTI FIELD-OF-VIEW MULTI SENSOR ELECTRO-OPTICAL FUSION-ZOOM CAMERA

(71) Applicant: BAE Systems Information and Electronic Systems Integration Inc., Nashua, NH (US)

(72) Inventors: Robert H. Murphy, Lancaster, MA (US); Stephen F. Sagan, Lexington, MA (US); Michael Gertsenshteyn, Lexington, MA (US)

(73) Assignee: BAE Systems Information and Electronic Systems Integration Inc., Nashua (US)

(21) Appl. No.: 14/404,715

(22) PCT Filed: Mar. 27, 2014
(86) PCT No.: PCT/US2014/031935

§ 371 Date: Dec. 1, 2014

Related U.S. Application Data
(60) Provisional application No. 61/805,547, filed on Mar. 27, 2013.

(51) Int. Cl. H04N 5/262; H04N 5/232

(52) U.S. Cl. CPC H04N 5/2621; H04N 5/23238
USPC 348/36

(57) ABSTRACT

A system and method for creating an image is presented. The system includes a first camera, a second camera, and a fusion processor. The first camera has a small field-of-view (FOV) and an optical line of sight (LOS). The second camera has a large FOV that is larger than the small FOV and the second camera has an optical LOS. The first camera and second camera are mounted so that the optical LOS of the first camera is parallel to the optical LOS of the second camera. The fusion processor fuses a second image captured by the second camera with a first image captured by the first camera. The fused image has better resolution in a fused portion of the fused image than in unfused portion of the fused image.

### BACKGROUND OF THE INVENTION

1. Field of Invention

The current invention relates generally to apparatus, systems and methods for taking pictures. More particularly, the apparatus, systems and methods relate to taking a picture with two or more cameras. Specifically, the apparatus, systems and methods provide for taking pictures with two or more cameras having multiple field-of-views and fusing their images into a single wide field-of-view image.

2. Description of Related Art

There have been prior attempts to use multiple sensors to detect an event. In particular, multiple cameras have been used to create a photograph that has a wider field-of-view (FOV) than can be captured using a single camera. For example, U.S. Pat. No. 6,771,208 describes a multi-sensor camera where each of the sensors are mounted onto a single substrate. Preferably the substrate is invar, a rigid metal that has been cured with respect to temperature so that its dimensions do not change with fluxuations in temperature. This system, however, requires the sensors to be located on a single substrate and does not provide for using two separate cameras that can be independently mounted.

U.S. Pat. No. 6,919,907 describes a camera system where a wide field-of-view is generated by a camera mounted to a motorized gimbal which combines images captured at different times and different directions into a single aggregate image. This system relies on covering a wide field-of-view by changing the direction of the camera and is able to simultaneously capture images from the multiple cameras. However, it does not provide for a system that uses two different cameras that do not need to be moved to capture an image.

U.S. Pat. No. 7,355,508 describes an intelligent and autonomous area monitoring system. This system autonomously identifies individuals in vehicles such as airplanes. However, this system uses both audio and visual data. Additionally, the multiple cameras of this system are all pointed in different directions adding complexity in created wide field-of-view images.

United States Application 2009/0080695 teaches a device in which a liquid crystal light valve and a lens array are essential. An array of lenses adds undesirable

mechanical complexity and expense to this camera system.

United States Application Nos. 2005/0117014 and 2006/0209194 rely on cameras that point in different directions and that stitch images from both together to cover a wide field-of-view. These systems are complex in that they both need to stitch together images from cameras pointed in different directions which is not easy to accomplish.

The above prior art systems all appear to require extraneous components or several steps to perform before producing a wide FOV image. For these reasons these prior art systems can be costly, time-consuming, and may not produce high quality images. A need, therefore exists, for a light-weight, low-size, and powerful multiple camera system that can produce an improved quality of larger FOV image.

### SUMMARY

The preferred embodiment of the invention may include a system and method for creating an image. The system includes a first camera, a second camera, and a fusion processor. The first camera has a small field-of-view (FOV) and an optical line of sight (LOS). The second camera has a large FOV that is larger than the small FOV and the second camera has an optical LOS. The first camera and second camera are mounted so that the optical LOS of the first camera is parallel to the optical LOS of the second camera. The fusion processor fuses a second image captured by the second camera with a first image captured by the first camera to create a final image. The fused image has better resolution in a portion of the final image than in another portion of the final image.

Another configuration of the preferred embodiment may include a sensor system that includes first and second sensors and a fusion processor. The first sensor has a first FOV and a LOS. The second sensor has a second FOV that is larger than the first FOV and a LOS that is parallel to the LOS of the first processor. The fusion processor merges a set of data collected by the first sensor with data collected by the second sensor to create merged data. The merged data has an area with high resolution and an area of lower resolution that has less resolution than the area with high resolution.

### BRIEF DESCRIPTION OF SEVERAL VIEWS OF THE DRAWINGS

The patent or application file contains at least one drawing executed in color. Copies of this patent or patent application publication with color drawing(s) will be provided by the Office upon request and payment of the necessary fee.

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a preferred embodiment of a camera system used to create wide field-of-view images with areas of enhancement.

FIG. 2 illustrates the example placement of three field-of-views.

FIG. 3 is an example illustration of an example photograph taken by a wide field-of-view camera according to preferred embodiment.

FIG. 4 is an example illustration of an example photograph taken by a narrow field-of-view camera according to preferred embodiment.

FIG. 5 is an example illustration of an example photograph of the wide and narrow field-of-view photographs of FIGS. 3 and 4 merged together according to the preferred embodiment.

FIG. 6 illustrates the preferred embodiment configured as a method of creating a wide field-of-view image.

Similar numbers refer to similar parts throughout the drawings.

### DETAILED DESCRIPTION

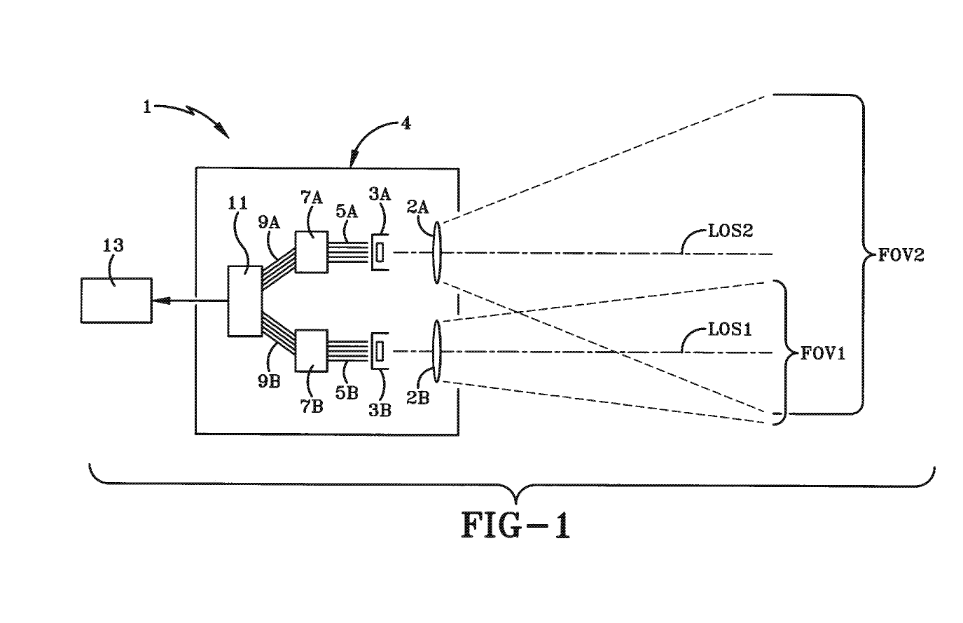

FIG. 1 illustrates the preferred embodiment of a camera system 1 that utilizes multiple co-located cameras each having a different field-of-view (FOV) FOV1, FOV2 and all of which point in the same direction. Camera 3A has a large FOV2 that is larger than the FOV1 of the second camera 3B. As seen in FIG. 1, the multiple FOV Cameras 3A-B are housed in a single housing 4. In other embodiments the cameras 3A-B are housed in separate housings. In the preferred embodiment, the cameras 3A-B are both optical cameras. However, in other configurations of the preferred embodiment, one or both of them can be infra-red (IR) cameras. In other embodiments, two or more cameras implementing the system 1 may be any combination of optical and IR cameras.

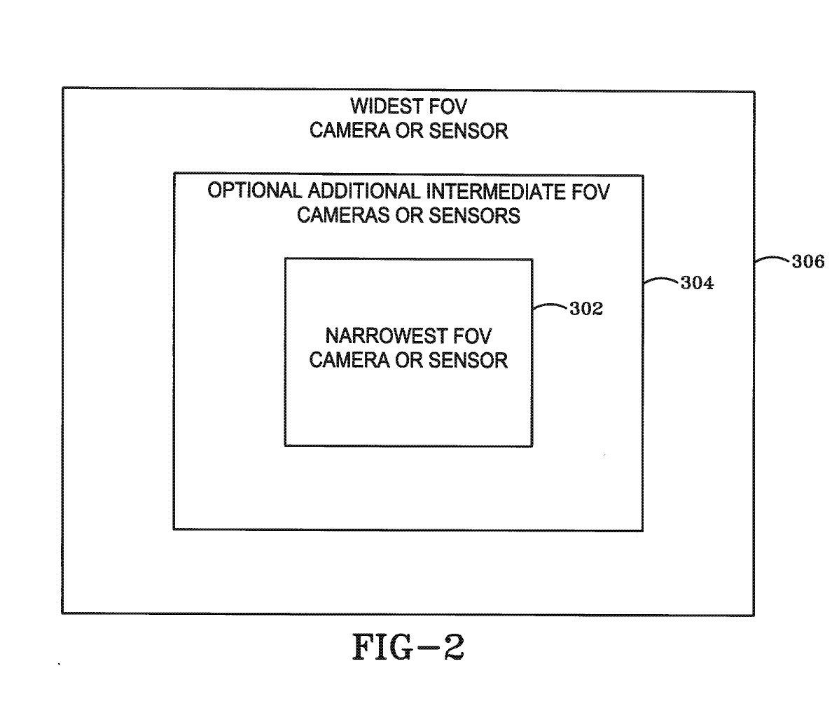

In the preferred embodiment, each camera 3A-B has a lens 2A, 2B. The optical Lines-Of-Sight (LOS) LOS1, LOS2 and optical axis of the cameras 3A, 3B are parallel. That is, each of the multiple cameras 3A, 3B are pointed in a common direction. In some embodiments the optical axis LOS1, LOS2 of each camera 3A, 3B are co-incident (co-axial). In other embodiments the optical axis LOS1, LOS2 of each camera 3A, 3B are adjacent but separated. In the example illustrated in FIG. 1 they are slightly separated. FIG. 2 illustrates an example of the FOVs of three different cameras with their LOSs placed co-incidental. This figure includes a narrow FOV 302 sensor, an optional sensor with a medium FOV 304, and a sensor having a large FOV 306.

The optical imagery 5A, 5B collected from the multiple cameras 3A, 3B is converted by digital processing logics 7A, 7B into digital signals 9A, 9B that, in the preferred embodiment, are digital pixels. However, in other configurations these signals are other kinds of signals rather than digital pixels. Each pixel can contain between 8 and 64 bits or can each be another number of bits. In the preferred embodiment, the digital signals 9A, 9B are input to a fusion processor 11 that outputs a single wide field-of-view image 13 that is output from the camera housing 4.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a processor such as a software controlled microprocessor, discrete logic, an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

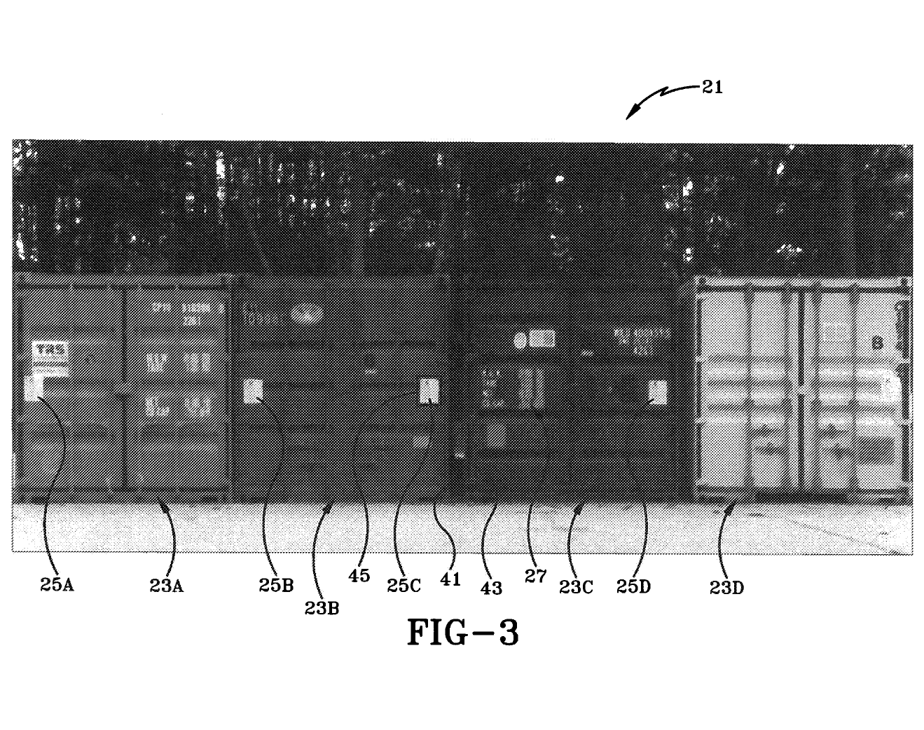

Having described the components of the preferred embodiment, its use and operation is now described. Referring to FIGS. 3-5, the preferred embodiment enhances the conventional zoom function of multi-field-of-view cameras and lens systems to produce an image that has higher resolution in its center than in its outer edges. By eliminating the need to move optical elements to zoom a conventional camera, several of the opto-mechanical problems found in the current approach are remedied. This is because the cameras 3A-B of optical system 1 have fixed FOVs so that no optical elements are moved.

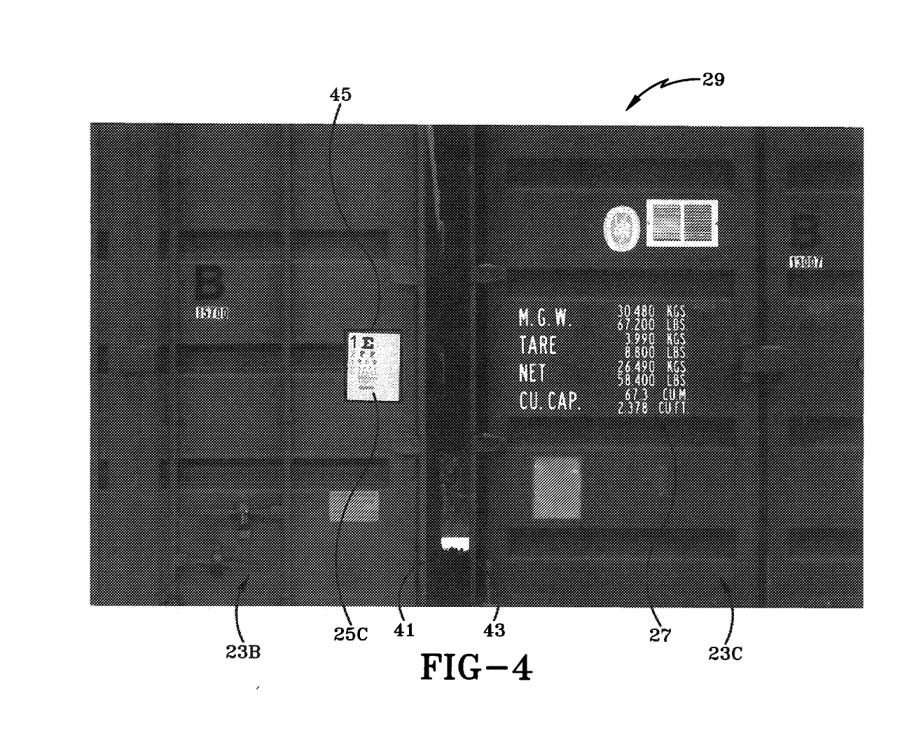

To generate an image with enhanced clarity near its center the camera system 1 simultaneously takes two pictures (images 5A-B) using both the cameras 3A-B. The camera 3A with the large FOV2 takes the picture 21 shown in FIG. 3 and the camera 3B with the smaller FOV1 takes the smaller, higher resolution picture shown in FIG. 4. Notice that picture 21 taken by the large FOV2 camera 3A captures an image of four cargo containers 23A-D. Some of the cargo containers 23A-D have eye charts 25A-D placed on them and cargo container 23C has additional lettering and numbering 27 on it.

The camera 3B with the smaller FOV1 captures the image shown in FIG. 4. This image has a smaller FOV but it has higher resolution. This image 29 includes portions of cargo containers 23B, 23C of picture 21 captured by the large FOV camera 3A of FIG. 3 as well as eye chart 25C and the numbers and lettering 27.

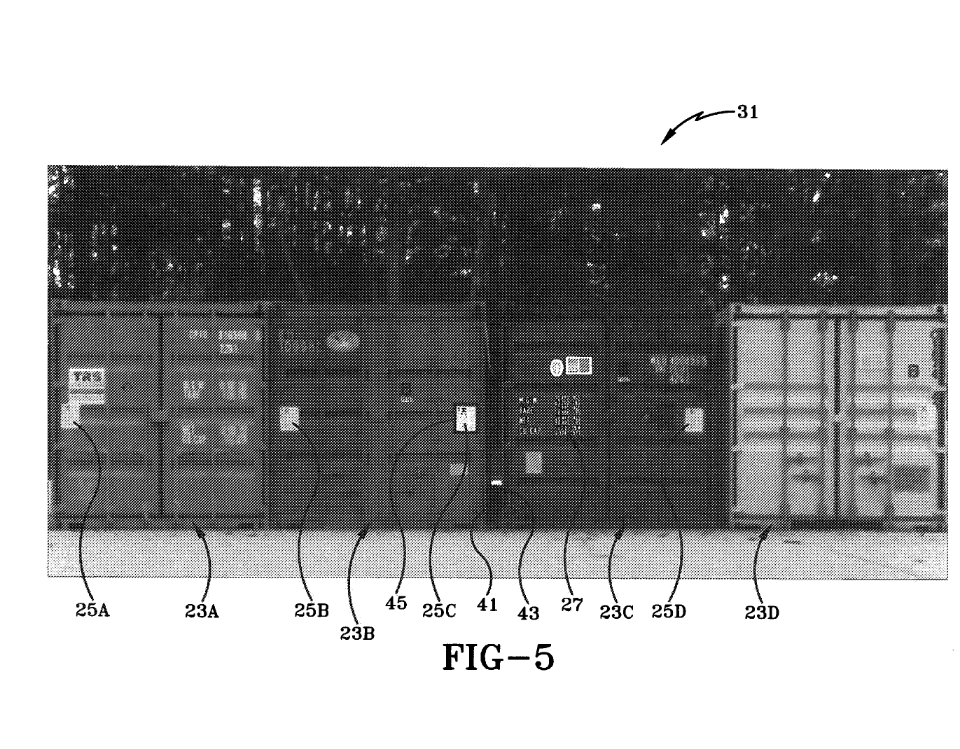

After each image 5A-B is taken the images are converted to digital images containing eight bits, in the preferred embodiment. In other embodiments, the pixels can be another number of bits. FIG. 5 illustrates an example picture 31 where the pictures 21, 29 of the large and small FOV cameras 3A, 3B have been fused (e.g., merged) into a final image 31. Notice that this image 31 contains the containers 23A-D, eye charts 25A-D and the lettering and numbering 27 of the image of the large FOV camera of FIG. 3. The center portion of the image 31 has been fused with the image 29 of the smaller FOV camera including portions of containers 23B and 23C as well as eye chart 25C and the lettering and numbering 27 of image 29. Thus image 31 of FIG. 5 has a much higher resolution near its center and less resolution on its outer boundaries.

The two 5A, 5B images are stitched and fused (e.g., merged together) in any of a number of ways as understood by those with ordinary skill in the art. In the preferred embodiment, the stitching/fusing is performed by the fusion processor 11 of FIG. 1. Also, this stitching/merging is generally performed automatically with software and/or a fusion processor 11 or another digital signal processor (DSP). One way to stitch the two images 5A, 5B together is to first look for common features in both of the images. For example, a right edge 41 (FIGS. 3-5) of container 23B and a left edge 43 of container 23C could be located in both pictures 21, 27. Additionally, an outside boundary 45 of eye chart 25C can also be located in both images 21, 29. Next, software logic can align the two pictures 21, 29 based on at least one or more of these detected similarities of both images 21, 29. After that, the smaller FOV1 image 29 can be placed inside the larger FOV2 image 21 to produce a resultant image 31 (FIG. 5) that has an image that has a better image quality near the center of the image than at the outer edges of the image 31.

The multiple cameras or image sensors can be configured in such a way that the entrance apertures are co-axial or simply located in near proximity to each other, but nonetheless pointing in the same direction. If required, the distance between the cameras or sensors can be restrained to be less than one hundred (100) times the largest aperture entrance.

Another advantage of the present invention is the inherent high line-of-sight stability due to the hard mounted optics with no or very few moving parts. In the prior art, conventional zoom and/or multi field-of-view lens assemblies suffer from inherently poor line-of-sight stability due to the necessity of moving optical elements to change the field-of-view. Additionally, as stated previously, the center of the fused image utilizes the highest resolution camera thereby providing inherent high resolution and image clarity toward the center of the field-of-view.

A further advantage of the preferred embodiment is the silent and instantaneous zoom and the ability to change the field-of-view. This is opposed to the prior art, wherein conventional zoom and/or multi-field-of-view lens assemblies suffer from inherently slow zoom and/or change field-of-view function that often generates unwanted acoustic noise. These problems are mitigated with the preferred embodiment due to the significant reduction or complete elimination of moving parts.

Another configuration of the example embodiment is a multi-field of view fusion zoom camera that consists of two or more cameras with different fields of view. This example embodiment consists of four cameras. Camera A has the smallest field of view (FOV), Camera B has the next larger FOV and subsequent Cameras C and D similarly have increasing FOVs.

When utilized as a multi FOV fusion zoom camera the FOV of Camera A is completely contained within the FOV of Camera B. The FOV of Camera B is completely contained within the FOV of Camera C. The FOV of Camera C is completely contained within the FOV of Camera D.

Imagery from two or more of the cameras captures the same or nearly the same scene at the same or nearly the same time. Each Camera, A-D, may have a fixed, adjustable or variable FOV. Each camera may respond to similar or different wavelength bands. The multiple cameras A-D may utilize a common optical entrance aperture or different apertures. One advantage of a common aperture design is the elimination of optical parallax for near field objects. One disadvantage of a common aperture approach is increased camera and optical complexity likely resulting in increased overall size, weight, and cost.

The multiple cameras may utilize separate optical entrance apertures where each is located within the near proximity of the others. Separate entrance apertures will result in optical parallax of close in objects. This parallax however may be removed through image processing and/or utilized to estimate the distance to various objects imaged by the multiple cameras. This however is a minor claim.

The imagery from the smaller FOV cameras is utilized to capture finer details of the scene and the imagery from the larger FOV cameras is utilized to capture a wider FOV of the same or nearly the same scene at the same or nearly the same point in time.

Additionally, the imagery from two or more cameras may be combined or fused to form a single image. This image fusion or combining may occur during image capture, immediately after image capture, shortly after image capture or at some undetermined point in time after image capture. The process of combining or fusing the imagery from the multiple Cameras A-D utilizes numerical or digital image upsampling with the following characteristics:

The imagery from Camera B is upsampled or digitally enlarged by a sufficient amount such that objects in the region of imagery from Camera B overlap the imagery from Camera A and effectively match in size and proportion. The imagery from Camera C is upsampled or digitally enlarged by a sufficient amount such that objects in the region of imagery from Camera C which overlap the imagery from Camera B after the imagery from camera B has been upsampled or enlarged by a sufficient amount such that objects in the region of imagery from Camera B overlapping the imagery from Camera A effectively match in size and proportion. This same process is repeated for images of subsequent Camera D and any additional cameras if there are any.

After the imagery from the multiple cameras has been upsampled or scaled such that all objects in the overlapping regions have similar size and proportion the imagery is combined such that the imagery from Camera A replaces the imagery from Camera B in the overlapping region between Camera A and Camera B and so on for Camera C, Camera D, etc. The imagery along the outside edge of the FOV of Camera A may be “feathered” or blended gradually.

In summary, this new approach enables changeable field-of-view and continuous or stepped zoom capability with greater speed, less noise, lower cost, improved line-of-sight stability, increased resolution and improved signal-to-noise ratio compared to conventional multi field-of-view, varifocal or zoom optical assemblies utilizing a single imaging device or a focal plane array.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

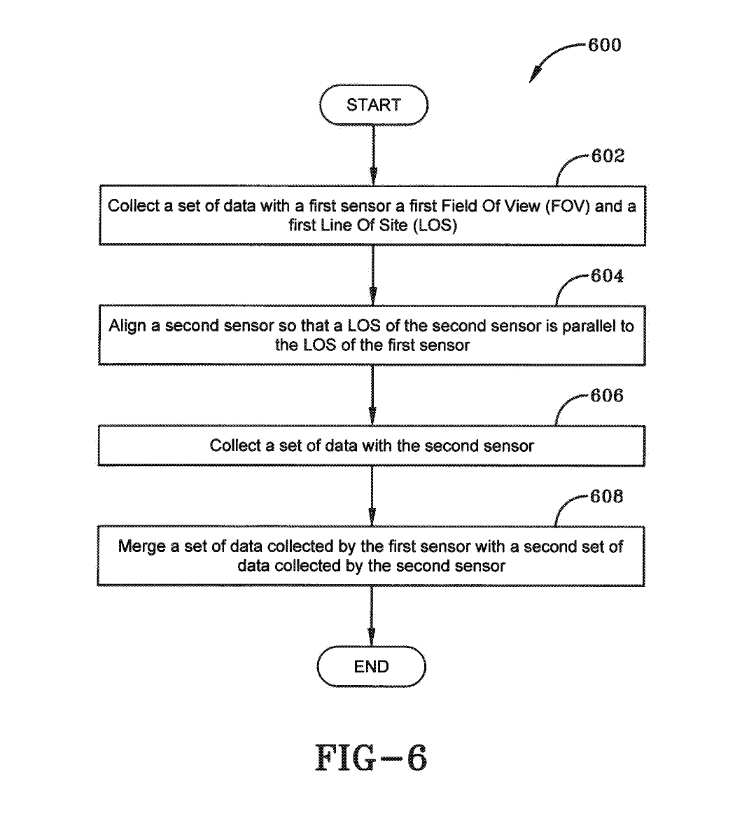

FIG. 6 illustrates a method 600 of creating a wide field-of-view image. The method 600 begins by collecting a set of data, at 602, with a first sensor with a first field-of-view (FOV). Next, a second sensor is positioned, at 604, so that it's LOS is parallel to the first LOS. A set of data is collected, at 606, with the second sensor that has a second FOV that is larger than the first FOV. The set of data collected by the first sensor is merged, at 608, with the set of data collected by the second sensor to create merged data that has an area with high resolution and an area of lower resolution that has less resolution than the area with high resolution.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A system for creating an image comprising:
a first camera with a first field-of-view (FOV) and an optical line of sight (LOS);
a second camera with a second FOV that is larger than the first FOV, wherein the second camera has an optical LOS;
a mounting device to mount the first camera and second camera so that the optical LOS of the first camera is parallel to the optical LOS of the second camera; and
a fusion processor configured to fuse a second image captured by the second camera with a first image captured by the first camera to produce a final image.

2. The system for creating an image of claim 1, wherein the final image with a first resolution in a first portion of the final image that is greater than a second resolution in a second portion of the final image.

3. The system for creating an image of claim 1 wherein the optical LOS of the first camera is coaxial with the optical LOS of the second camera.

4. The system for creating an image of claim 1 further comprising:
a third camera with a third FOV that is larger than the second FOV of the second camera, wherein the third camera has an optical LOS, so that the optical LOS of the first camera is parallel to the optical LOS of the third camera; and wherein the fusion processor is to fuse a third image captured by the third camera with the first image captured by the first camera and with the second image captured by the second camera to produce the final image.

5. The system for creating an image of claim 1 wherein the first and second cameras are optical cameras.

6. The system for creating an image of claim 1 wherein the fusion processor is configured to upsample the second image to enlarge images in the second image so that objects in regions of the second image from the second camera match in size the objects of the first image taken by the first camera.

7. The system for creating an image of claim 1 further comprising:
a first housing with the first camera mounted in the first housing; and
a second housing that is spaced apart from the first housing with the second camera mounted in the second housing.

8. The system for creating an image of claim 1 wherein the first camera has a FOV that is variable.

9. The system for creating an image of claim 1 wherein a distance between the first camera and the second camera is less than 100 times a largest aperture entrance of both the first camera and the second camera.

10. The system for creating an image of claim 1 further comprising:
a physical mounting platform with the first camera and second camera physically mounted to the mounting platform so that the first camera cannot move relative to the second camera.

11. The system for creating an image of claim 1 wherein the system is free of moving parts.

12. The system for creating an image of claim 1 wherein the first camera is an infra-red (IR) camera and the second camera is an optical camera.

13. The system for creating an image of claim 1 wherein the first camera is adapted to capture images in a first frequency range and the second camera is adapted to capture images in a second frequency range that is different than the first frequency range.

14. The system for creating an image of claim 13 wherein the first frequency range is a single frequency.

15. The system for creating an image of claim 1 wherein the first image further comprises:
a plurality of pixels.

16. A sensor system comprising:
a first sensor with a first field-of-view (FOV) and a first line of site (LOS);
a second sensor with a second FOV that is larger than the first FOV and a LOS that is parallel to the LOS of the first sensor; and
a fusion processor to merge a set of data collected by the first sensor with a set of data collected by the second sensor to create merged data that has an area with first resolution and an area of second resolution that has a lower resolution than the first resolution.

17. The sensor system of claim 16 wherein the first LOS and the second LOS are coaxial.

18. The sensor system of claim 16 wherein the first sensor is an optical camera.

19. A method of creating a wide field-of-view image comprising:
collecting a set of data with a first sensor with a first field-of-view (FOV) and a first line of site (LOS);
aligning a second sensor so that a second LOS of the second sensor is parallel to the first LOS of the first sensor;
collecting a second set of data with the second sensor with a second FOV that is larger than the first FOV; and
merging a set of data collected by the first sensor with the second set of data collected by the second sensor to create merged data that has an area with first resolution and an area with a second resolution that has a lower resolution than the first resolution.

20. The method of creating a wide field-of-view image of claim 19 further comprising:
locating an object in the first set of data;
locating the object in the second set of data; and
wherein the merging the set of data collected by the first sensor with the second set of data is based, at least in part, on a location of the object in the first set of data and a location of the object in the second set of data.
